(19) United States
(12) Patent Application Publication
(10) Pub. No.: US 2005/0223533 A1
(43) Pub. Date: Oct. 13, 2005

(54) One man front backing plate nutrunner and process for using on an assembly line

(76) Inventors: Rand D. Smith, Springfield, OH (US); Paul S. Mikulich, Urbana, OH (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/029,738

(22) Filed: Jan. 5, 2005

Related U.S. Application Data
(60) Provisional application No. 60/534,248, filed on Jan. 5, 2004.

(51) Int. Cl. B23P 11/00

(52) U.S. Cl. 29/429

(57) ABSTRACT

The invention involves a one-man front backing plate runner and the associated process for use on a vehicle assembly line. The invention includes the reaction arm being held relatively stationary relative to the assembly line and the drive motor being slidable to engage with the member of the fastener pair that is not engaged to the reaction arm. This eliminates the need for a second assembly worker to hold the part of the fastener pair that is not to be engaged to the motorized socket as well as accounting for limiting access for a slidable reaction arm in assembly line procedures.

This patent issues from a non-provisional patent application claiming the priority of provisional patent application Ser. No. 60/534,248, filed Jan. 5, 2004.

### BACKGROUND OF INVENTION

Improving vehicle assembly line processes presents many challenges to manufacturing engineers and technicians. One of these is the process of installing bolts and nuts. One specific challenge is allowing single assembly employee installation of nuts and bolts on vehicles, in particular the installation of brake backing plates to axles during motor vehicle manufacture. The original process for this installation involved manually inserting the bolt through a component to be installed and the mounting holes on the base component or vehicle chassis for a vehicle. The worker then manually installed the nut and then tightening with a torque wrench. Modern processes involved the use of motorized wrenches such as shown in the prior art configuration shown in FIG. 1. Such motorized wrenches 10 have a drive motor 11 and a drive socket 12 for driving one of the nuts and bolts. These prior art assemblies included a reaction arm 13 and a reaction socket 14 for holding the other of the nut and bolt stationary. The drive motor 11 was held substantially stationary relative to the assembly line and the reaction arm 13 slidable relative to the drive motor and the assembly line. The prior art motorized wrench 10 was used by the assembly line worker manually engaging the drive socket 12 to either the nut or the bolt, and then activating the motor 11, which drew the slidable reaction arm 13 into engagement with the other of the nut or bolt that was not already engaged to the motor drive socket 12. This prior art method was acceptable where there is unlimited room for assembly and hence room for reaction arm movement relative to the assembly line. An additional problem was that there was some potential for personal injury where a second operator had to hold a backup wrench during installation while the first operator ran the motorized wrench. This invention involves a one-man front backing plate runner and the associated procedure for use in which the reaction arm is held relatively stationary relative to the assembly line and the drive motor is slidable. This eliminates the need for a second assembly worker to hold the part of the fastener pair that is not to be engaged to the motorized socket as well as accounting for limiting access for a slidable reaction arm in assembly line procedures.

### SUMMARY

The invention involves a one-man front backing plate runner and the associated process for use on a vehicle assembly line. The invention includes the reaction arm being held relatively stationary relative to the assembly line and the drive motor being slidable to engage with the member of the fastener pair that is not engaged to the reaction arm. This eliminates the need for a second assembly worker to hold the part of the fastener pair that is not to be engaged to the motorized socket as well as accounting for limiting access for a slidable reaction arm in assembly line procedures. The improved tool has a holding arm that captures the nut an air cylinder or other engaging mechanism that pulls the tool into the bolt.

### DRAWINGS

Other objects and advantages of the invention will become more apparent upon perusal of the detailed description thereof and upon inspection of the drawings, in which:

FIG. 1 is a prior art motorized wrench configuration.

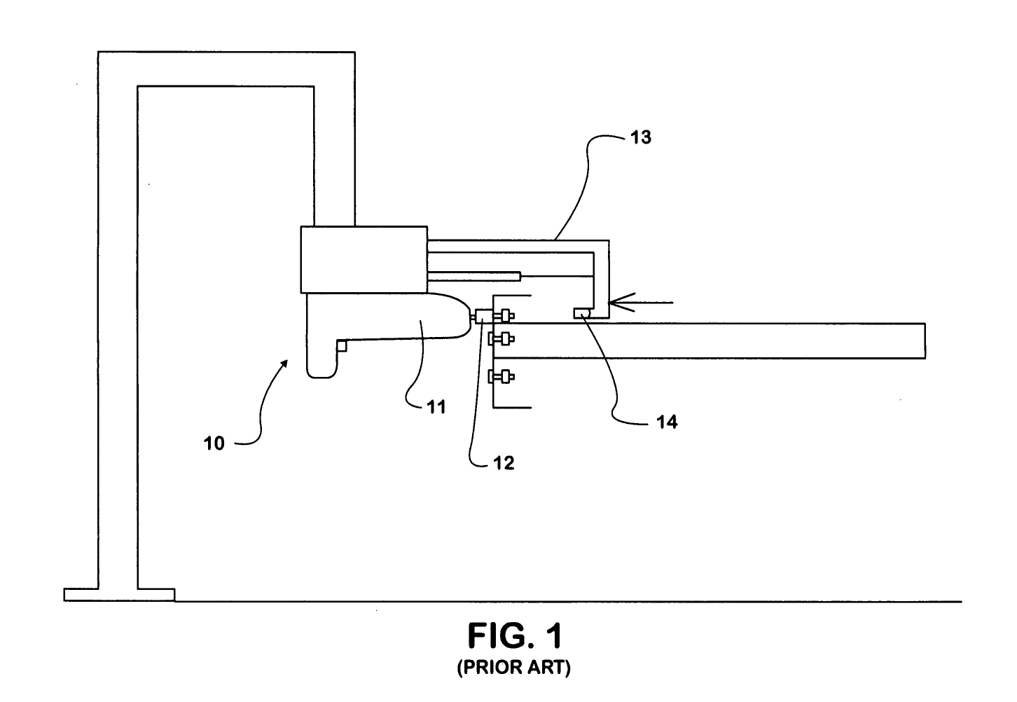

FIG. 2 is a single assembly worker front backing plate nut runner motorized wrench tool configuration made in accordance with this invention.

FIG. 3 is an example of a vehicle assembly line upon which the tool configuration of FIG. 2 may be used.

FIG. 4 is a flow chart of one embodiment of a process that may use the tool configuration of FIG. 2.

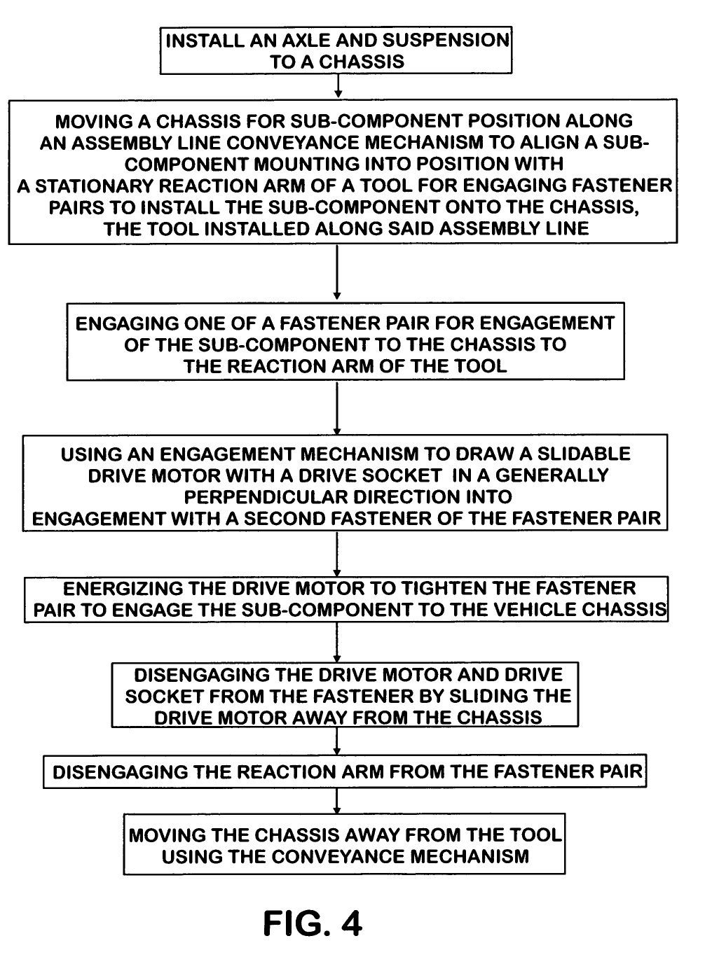

### DESCRIPTION OF INVENTION

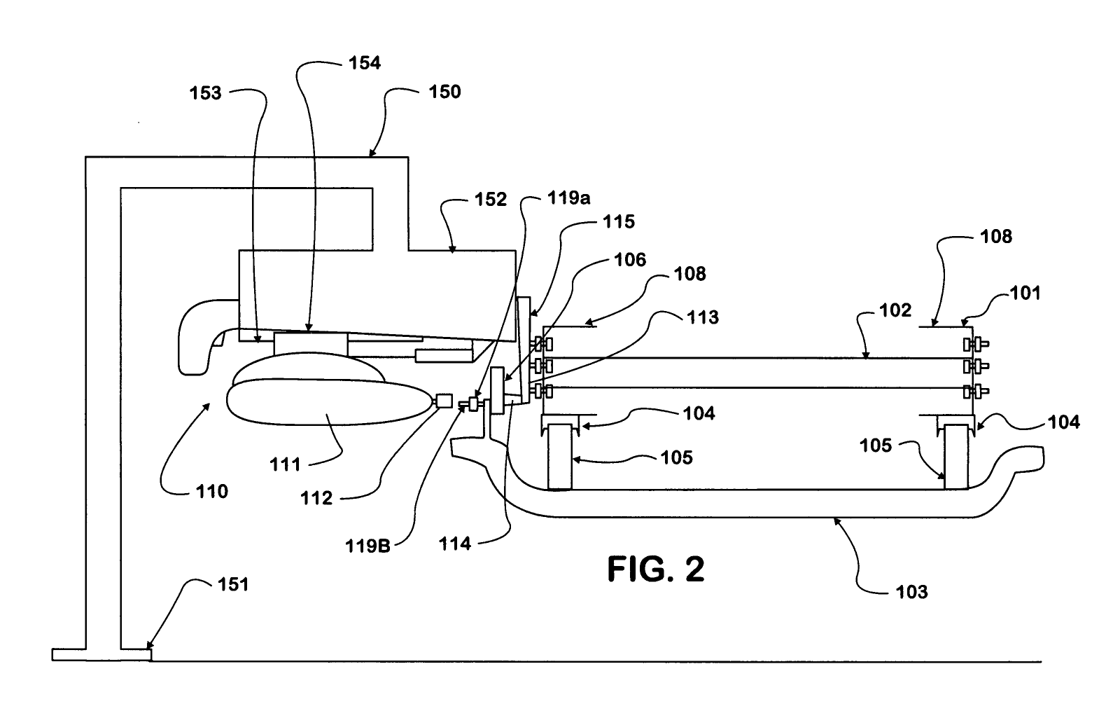

A one-man or single assembly worker front backing plate runner tool configuration for use on a vehicle assembly line is shown in FIG. 2 and is made in accordance with the invention. There is a reaction arm 113 that is held relatively stationary relative to the assembly line that moves perpendicular to the figure. There is a motor drive 111 with a drive socket 112 that is slideable relative to the assembly line and the reaction arm 113. The motor drive 111 has an engagement mechanism 154 that draws the motor drive 111 and drive socket 112 into engagement with one of the parts of a fastener pair 119a or 119b, with the reaction arm 113 in engagement with the other part of the fastener pair 119a or 119b. The fastener pair 119a and 119b may be a bolt and nut. The invention is new in that the drive motor moves relatively with respect to an assembly line and the reaction arm is relatively fixed. In a preferred embodiment this relative movement of the drive motor with respect to the fasteners is perpendicular to the assembly line.

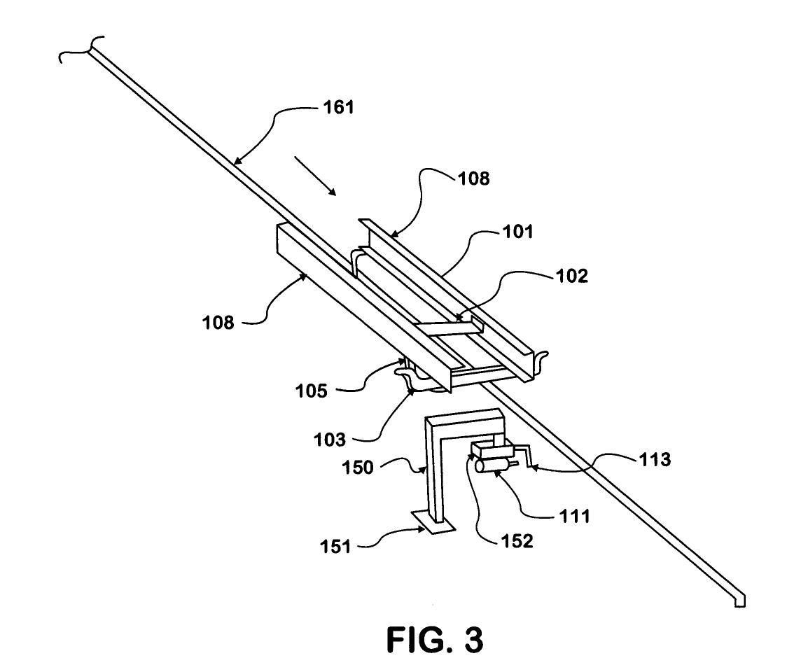

The tool of FIG. 2 can be used to assemble a fastener pair(s) 119a and 119b on a motor vehicle 101 as shown in FIG. 2 and FIG. 3. The vehicle 101 has a chassis comprised of a parallel set of frame rails 108 joined by at least one chassis cross member 102. An axle 103 is engaged to the frame rails 108 through suspension brackets 104 and suspension members 105. The tool of this invention may be used to engage a brake backing plate 106 to the axle 103 through the fastener pair 119a or 119b. The fastener pair 119a and 119b may be a bolt and nut that require some tightening or engagement between the members of the pair.

The tool of FIG. 2 may be further comprised of a base platform 151 with a drive mechanism arm 150. The drive mechanism arm 150 holds a drive mounting body 152 that includes a motor drive rail 153 upon which the motor drive 111 may travel. The motor drive 111 is propelled along the drive rail 153 by the engagement mechanism 154. The reaction arm 113 is engaged to the drive mounting body 152. The reaction arm 113 is substantially stationary relative to the assembly line. The engagement mechanism 154 may be an air cylinder, other pneumatic device, or mechanism for moving the drive motor and sprocket into engagement with the fastener pair.

In use, the fastener pair 119a and 119b are moved into position to be engaged. Where there is an assembly line as shown in FIG. 3, the fastener pair 119a and 119b is moved into position along with a motor vehicle chassis via a conveyance mechanism 161 that moves the chassis from one assembly station to another. To use the tool of this invention, one of the parts of the fastener pair 119a and 119b is engaged to the stationary reaction arm 113. This is accomplished due to give or play in the assembly line or conveyance mechanism to allow movement to engage the part of the fastener pair to the fixed reaction arm 113. The assembly line worker than uses the engagement mechanism 154 to draw the motor drive 111 and drive sprocket 112 into engagement with the other part of the fastener pair 119a or 119b, not in engagement with the reaction arm 113. The drive motor 111 than inputs the force, torsional for nuts and bolts as fasteners, to engage the fastener pair 119a and 119b together. In the process shown FIG. 5, this results in the engagement of a component to a vehicle 101. Where there is a vehicle 101 being assembled, workers first install the axle 103, and suspension 105 to frame rails 108 of the chassis. The vehicle 101 is moved by a conveyance mechanism along the assembly line to the sub-component installation station. For FIG. 2, the sub-component is a brake pad backing plate 106. Then the tool is used as described above to install the sub-component onto the axle using the movable drive motor and socket and stationary reaction arm.

As described above, the one-man front backing plate runner with motor that operates with respect to an assembly line and the associated process of this invention provide a number of advantages, some of which have been described above and others of which are inherent in the invention. Also modifications may be proposed to the one-man front backing plate runner and the associated process of this invention without departing from the teachings herein.

1. A tool for engaging fastener pairs comprised of a first part and a second part to install components along an assembly line, comprising:
a reaction arm being stationary relative to the assembly line;
said reaction arm having a fixture for engaging the first component of the fastener pair;
a drive motor with a drive socket;
said drive motor being slideable relative to the assembly line and said reaction arm;
an engagement mechanism attached to said drive motor for drawing said drive motor into engagement with a second component of a fastener pair to allow an assembly line operator to energize said drive motor to engage the fastener pair.

2. The tool of claim 1, comprising:
a base platform with a drive mechanism arm;
said drive mechanism arm holding a drive mounting body that includes a motor drive rail upon which the drive motor travels;
said drive motor being propelled along said drive rail by said engagement mechanism; and
said reaction arm being engaged to said drive mounting body.

3. The tool of claim 2, wherein:
said engagement mechanism is pneumatic device.

4. The tool of claim 3, wherein:
said engagement mechanism moves said drive motor generally perpendicular to the track of the assembly line.

5. An assembly line for manufacturing a motor vehicle, the motor vehicles having chassis with at least one axle, the vehicles requiring engagement of sub-components through fastener pairs, comprising:
a conveyance mechanism for engaging to and moving a motor vehicle chassis from one assembly location to another;
a tool for engaging fastener pairs to install a vehicle sub-component onto said chassis, said tool installed along said assembly line;
said tool having a reaction arm being mounted stationary relative to said assembly line;
said reaction arm having a fixture for engaging the first component of the fastener pair;
a tool for engaging fastener pairs having a drive motor with a drive socket; said drive motor being slideable relative to said assembly line and said reaction arm;
an engagement mechanism attached to said drive motor for drawing said drive motor into engagement with a second component of a fastener pair to allow an assembly line operator to energize said drive motor to engage the fastener pair.

6. The assembly line of claim 5, wherein said tool comprising:
a base platform with a drive mechanism arm;
said drive mechanism arm holding a drive mounting body that includes a motor drive rail upon which the drive motor travels;
said drive motor being propelled along said drive rail by said engagement mechanism; and
said reaction arm being engaged to said drive mounting body.

7. The assembly line of claim 6, wherein said vehicle sub-component to be installed on said chassis being a brake pad back plate onto an axle of said chassis.

8. The assembly line of claim 7, wherein:
said engagement mechanism is pneumatic device.

9. The assembly line of claim 8, wherein:
said engagement mechanism moves said drive motor generally perpendicular to the track of said assembly line.

10. A process for installing a sub-component onto a chassis of a motor vehicle, the chassis having at least one axle, comprised of the steps of:
moving a chassis for sub-component position along an assembly line conveyance mechanism to align a sub-component mounting into position with a stationary reaction arm of a tool for engaging fastener pairs to install the sub-component onto the chassis, the tool installed along said assembly line;
engaging one of a fastener pair for engagement of the sub-component to the chassis to the reaction arm of the tool;
using an engagement mechanism to draw a slidable drive motor with a drive socket in a generally perpendicular direction into engagement with a second fastener of the fastener pair;
energizing the drive motor to tighten the fastener pair to engage the sub-component to the vehicle chassis;
disengaging the drive motor and drive socket from the fastener by sliding the drive motor away from the chassis;
disengaging the reaction arm from the fastener pair; and
moving the chassis away from the tool using the conveyance mechanism.

11. The process of claim 10, wherein:
said steps of moving said drive motor and drive socket into position to tighten the fasteners uses a pneumatic engagement mechanism.

12. The process of claim 11, further comprising the step of installing an axle and suspension to the chassis prior to the step of moving the chassis into position for sub-component installation.

13. The process of claim 12, wherein the sub-component to be installed to the axle is a brake pad backing plate.
